(19) United States
(12) Patent Application Publication
(10) Pub. No.: US 2020/0030914 A1
(43) Pub. Date: Jan. 30, 2020

(54) WELDING METHOD, METHOD FOR MANUFACTURING WELDED PRODUCT, AND WELDED PRODUCT

(71) Applicants: Kabushiki Kaisha Toshiba, Minato-ku (JP); Toshiba Electronic Devices & Storage Corporation, Minato-ku (JP)

(72) Inventors: Lisa MASUDA, Yokohama (JP); Ryuichi TOGAWA, Machida (JP); Takashi OBARA, Yokohama (JP); Tomohiko YAMADA, Yokohama (JP)

(73) Assignees: Kabushiki Kaisha Toshiba, Minato-ku (JP); Toshiba Electronic Devices & Storage Corporation, Minato-ku (JP)

(21) Appl. No.: 16/355,770

(22) Filed: Mar. 17, 2019

(30) Foreign Application Priority Data
Jul. 25, 2018 (JP) 2018-139421

(51) Int. Cl. B23K 26/26; B23K 26/00

(52) U.S. Cl. CPC B23K 26/26; B22D 17/00; B23K 26/0006; B23K 26/0093

(57) ABSTRACT

According to an embodiment, a welding method comprises pretreatment of melting a part of the first member formed by die casting and solidifying the part of the first member. The method may comprise welding the first member and the second member by melting the solidified part of the first member and the second member in contact with each other.

### CROSS-REFERENCE TO RELATED APPLICATIONS

This application is based upon and claims the benefit of priority from Japanese Patent Application No. 2018-139421, filed on Jul. 25, 2018; the entire contents of which are incorporated herein by reference.

### FIELD

Embodiments described herein relate generally to a welding method, a method for manufacturing a welded product, and a welded product.

### BACKGROUND

In welding, two or more members are melted and integrated to one member. It is desirable that there are few defects in a welded portion where the members are welded together.

### BRIEF DESCRIPTION OF THE DRAWINGS

FIG. 1 is a perspective view illustrating a member to be welded by a welding method according to an embodiment;

FIG. 2 is a flowchart showing the welding method according to the embodiment;

FIG. 3A to FIG. 3F are process sectional views showing the welding method according to the embodiment; and

FIG. 4A is a perspective view showing a welded product manufactured using the welding method according to the embodiment and FIG. 4B is a cross-sectional view taken along line A-A′ of FIG. 4A.

### DETAILED DESCRIPTION

According to an embodiment, a welding method comprises pretreatment of melting a part of the first member formed by die casting and solidifying the part of the first member. The method may comprise welding the first member and the second member by melting the solidified part of the first member and the second member in contact with each other.

According to the embodiment, a method for manufacturing a welded product including a first member formed by die casting and a second member comprises pretreatment of melting a part of the first member formed by die casting and solidifying the part of the first member. The method may comprise welding the first member and the second member by melting the solidified part of the first member and the second member in contact with each other.

According to the embodiment, a welded product comprises a first portion including a metal and a second portion connected to the first portion via a welded portion. The first portion includes a first region apart from the welded portion and a second region provided between the first region and the welded portion. A density of voids in the second region is lower than a density of voids in the first region.

Embodiments of the invention will now be described with reference to the drawings.

The drawings are schematic or conceptual; and the relationships between the thicknesses and widths of portions, the proportions of sizes between portions, etc., are not necessarily the same as the actual values thereof. The dimensions and/or the proportions may be illustrated differently between the drawings, even in the case where the same portion is illustrated.

In the drawings and the specification of the application, components similar to those described thereinabove are marked with like reference numerals, and a detailed description is omitted as appropriate.

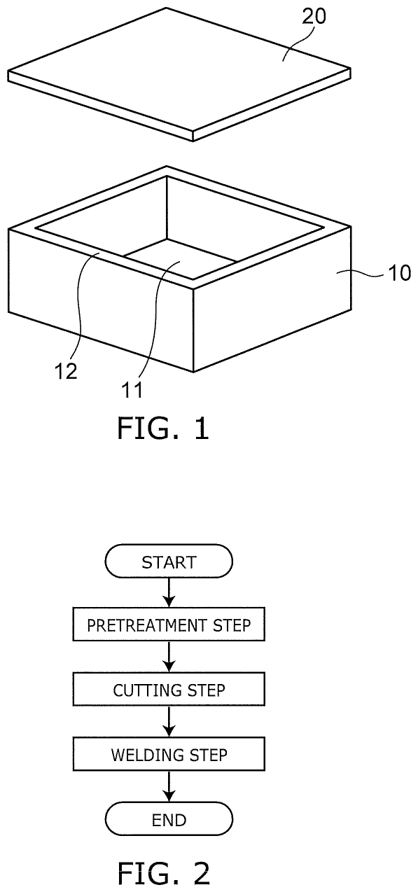

FIG. 1 is a perspective view illustrating a member to be welded by the welding method according to the embodiment.

As an example, a first member 10 and a second member 20 shown in FIG. 1 are welded together in the welding method according to the embodiment. The first member 10 includes a concave portion 11 and a convex portion 12 provided around the concave portion 11. The second member 20 has a flat shape. For example, the convex portion 12 of the first member 10 and the outer periphery of the second member 20 are welded. As a result, the space surrounded by the concave portion 11, the convex portion 12, and the second member 20 is sealed.

The first member 10 is formed by die casting. In die casting, molten metal is pressed into a metal mold. Thereafter, the metal solidifies ; and a member to which the shape of the mold is transferred is formed. The first member 10 includes, for example, aluminum, magnesium, zinc, copper, or iron. As long as the first member 10 and the second member 20 can be welded, the shape, material, manufacturing method, and the like of the second member 20 can be appropriately changed. For example, a metal included in the second member 20 is the same as a metal included in the first member 10.

FIG. 2 is a flowchart showing the welding method according to the embodiment.

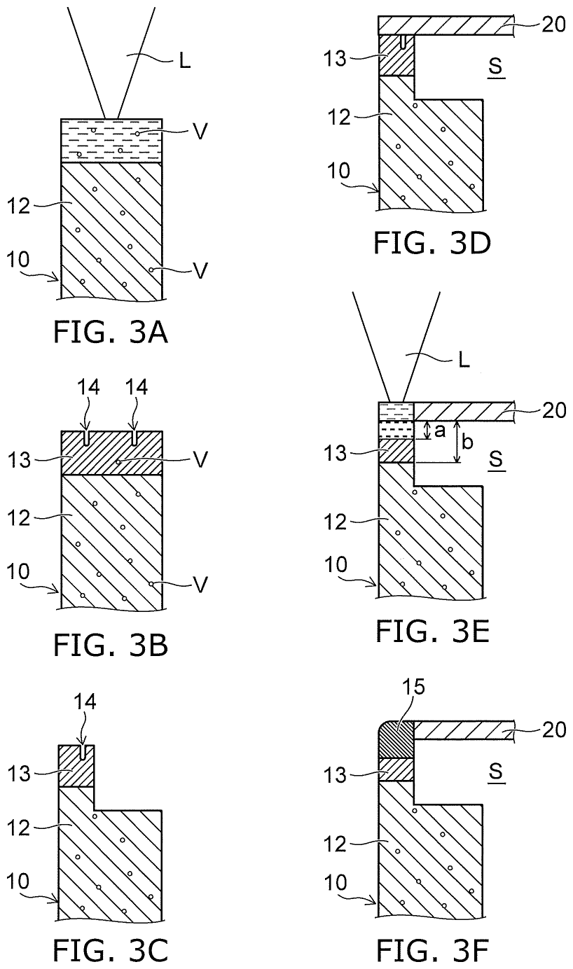

FIG. 3A to FIG. 3F are process sectional views showing the welding method according to the embodiment.

As shown in FIG. 2, the welding method according to the embodiment includes a pretreatment step and a welding step. In the example shown in FIG. 2, the welding method further includes a cutting step. Each of the steps will be specifically described below.

In the pretreatment step, as shown in FIG. 3A, a part of the first member 10 (the surface of the convex part 12) is irradiated with the laser light L. The part of the first member 10 is heated and melted by the laser light L. The first member 10 may be heated with an electron beam or the like instead of the laser light.

For example, when the first member 10 includes aluminum, the part of the first member 10 is heated to 660 degrees Celsius or higher. When the first member 10 includes iron, the part of the first member 10 is heated to 1540 degrees Celsius or higher. When the first member 10 is made of an alloy, the part of the first member 10 is heated above the melting point of the alloy.

A large number of voids V are present inside the first member 10 formed by die casting. The void V is a cavity formed during die casting. The void V is generated as the gas in the welded metal is not released into the atmosphere but is confined in the metal. When the part of the first member 10 melts and the gas in the void V expands by heating, the molten metal is blown off and the gas is released from the first member 10.

When the gas is released, the molten metal flows into the void V, and the void V is buried. Thereafter, when the molten portion is cooled and solidified, a portion having a low density of voids V is formed as shown in FIG. 3B. Hereinafter, for the sake of convenience of explanation, this portion formed by solidifying again after die casting is referred to as re-solidified layer 13. The re-solidified layer 13 may not include the void V. The density of the voids V in the re-solidified layer 13 may be zero.

A depression 14 may be formed on the surface of the re-solidified layer 13. The depression 14 is formed by the molten metal being blown off by the expanded gas in the void V. In the present specification, “void” refers to a cavity provided inside the first member 10. “Void” does not include the depression 14 formed on the surface of the re-solidified layer 13. When calculating the density of the voids, the depression 14 is not taken into account.

When welding the first member 10 and the second member 20, and sealing the space inside these members, the laser light L is sequentially irradiated on the surface of the convex portion 12 along the circumferential direction. Thereby, the re-solidified layer 13 having less voids V is formed over the entire circumference of the convex portion 12.

In the cutting step, as shown in FIG. 3C, the first member 10 is cut so that the first member 10 has a predetermined shape. The cutting position, size, shape, etc. can be appropriately changed. The first member 10 is cut so that at least a portion of the re-solidified layer 13 remains.

In the welding step, as shown in FIG. 3D, the re-solidified layer 13 of the first member 10 and the second member 20 are brought into contact with each other. As shown in FIG. 3E, the laser light L is irradiated to the re-solidified layer 13 and the second member 20. The re-solidified layer 13 and the second member 20 are heated and melted. At this time, when the depression 14 exists on the surface of the re-solidified layer 13, the molten metal flows into the depression 14, and the depression 14 is buried.

The melted re-solidified layer 13 and the melted second member 20 mix and solidify to form a welded portion 15 as shown in FIG. 3F. The first member 10 and the second member 20 are joined via the welded portion 15, and an integrated welded product is manufactured.

When sealing the space S inside the first member 10 and the second member 20, in the welding step, similarly to the pretreatment step, the laser light L is irradiated to the re-solidified layer 13 and the second member 20 along the circumferential direction. As a result, the convex portion 12 of the first member 10 and the outer periphery of the second member 20 are welded, and the space S is sealed.

The effects of the embodiment will be described.

As described above, the first member 10 formed by die casting includes a large number of voids V. The gas in these voids V expands and blows off the molten metal when the first member 10 is heated. When this phenomenon occurs at the time of welding the first member 10 and the second member 20, a defect (gap) is generated in the welded portion. If a defect occurs in the welded portion, there is a possibility that the first member 10 and the second member 20 are not properly welded together. When the space surrounded by the first member 10 and the second member 20 is sealed by welding, if there is a defect in the welded portion, the airtightness of the space decreases. Therefore, when welding the first member 10 and the second member 20, it is desirable that defects do not easily occur.

In the welding method according to the embodiment, the pretreatment step is performed before the welding step. By the pretreatment step, the re-solidified layer 13 is formed in the first member 10. In the re-solidified layer 13, as described above, the number of the voids V is smaller than that of other portions of the first member 10. By welding the re-solidified layer 13 and the second member 20, occurrence of defects in the welded portion 15 can be suppressed. For example, when the space surrounded by the first member 10 and the second member 20 is sealed by welding, airtightness of this space can be improved.

When there is no need to process the shape of the first member 10, the welding method according to the embodiment may not include the cutting step. When the cutting step is performed, the order of the cutting step and the pretreatment step can be appropriately changed. Preferably, the cutting step is performed after the pretreatment step. In the pretreatment step, a part of the first member 10 is melted. Therefore, the shape of the first member 10 may change. By performing the cutting step after the pretreatment step, it is possible to prevent the shape of the first member 10 obtained by the cutting step from changing. As a result, the first member 10 having a desired shape can be welded to the second member 20.

When the part of the first member 10 is melted in the welding step, as shown in FIG. 3E, it is desirable that the depth a of the first member 10 to be melted is shallower than the thickness b of the re-solidified layer 13. If the depth a is deeper than the thickness b, in addition to the re-solidified layer 13, a portion having a large number of voids V other than the re-solidified layer 13 is also melted. For this reason, defects tend to occur in the welded portion 15. By making the depth a shallower than the thickness b, only a part of the re-solidified layer 13 can be melted. Occurrence of defects in the welded portion 15 is effectively suppressed.

In the welding step, it is desirable that the heating temperature for melting the re-solidified layer 13 is set lower than the heating temperature for melting the part of the first member 10 in the pretreatment step. According to this condition, the depth a can be made shallower than the thickness b more surely. When laser light is used for heating in the pretreatment step and welding step, for example, the power of the laser light in the welding step is set to be lower than the power of the laser light in the pretreatment step. Or the irradiation time per unit area of the laser light in the welding step is set shorter than the irradiation time per unit area of the laser light in the pretreatment step.

Even if a defect occurs in the welded portion 15, there is a possibility that the first member 10 and the second member 20 are sufficiently bonded. Welding of the first member 10 and the second member 20 may be achieved. However, when sealing the space inside the first member 10 and the second member 20, if there is a defect in the welded portion 15, the space can not be sealed. Therefore, the welding method according to the embodiment is particularly suitable for manufacturing the sealing housing by welding the first member 10 and the second member 20 and sealing the space surrounded by these members.

The welding method and the method for manufacturing a welded product according to the embodiment described above are, for example, applied to a device such as a secondary battery, a heat exchanger such as a heat sink, a gas generator used for an air bag or the like, a rotor for an air conditioner. In the manufacturing process of these devices, two or more members are welded, and the space inside these members is sealed, so that the sealing housing is manufactured.

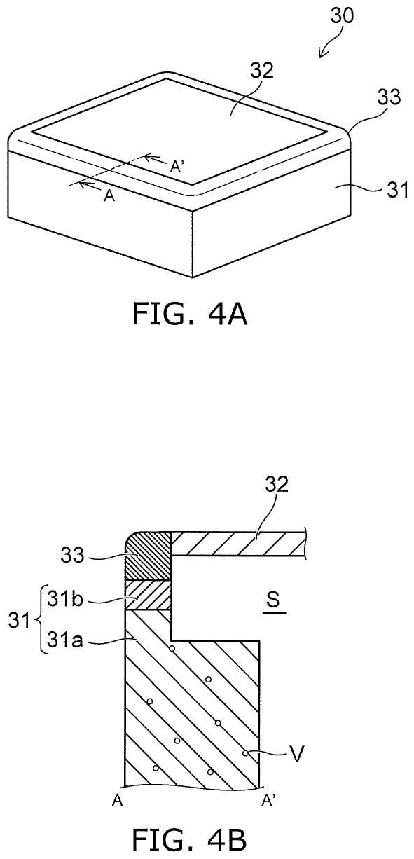

With reference to FIG. 4A and FIG. 4B, a member manufactured by the welding method according to the embodiment will be described.

FIG. 4A is a perspective view showing a welded product manufactured using the welding method according to the embodiment. FIG. 4B is a cross-sectional view taken along line A-A′ of FIG. 4A.

The welded product 30 shown in FIG. 4A has a first portion 31 and a second portion 32. The first portion 31 and the second portion 32 respectively correspond to the first member 10 and the second member 20 shown in FIG. 1. Accordingly, the first portion 31 includes a metal used for die casting such as aluminum, magnesium, zinc, copper, and iron. The second portion 32 includes, for example, the same metal as the first portion 31.

As shown in FIG. 4B, a welded portion 33 exists between the first portion 31 and the second portion 32. The second portion 32 is connected to the first portion 31 via the welded portion 33. The welded portion 33 is formed by solidification after the first member 10 and the second member 20 are melted and mixed together.

The first portion 31 includes a first region 31a and a second region 31b. The first region 31a is apart from the welded portion 33. The second region 31b is located between the first region 31a and the welded portion 33. The density of the voids V in the second region 31b is lower than the density of the voids V in the first region 31a. The second region 31b corresponds to a part of the re-solidified layer 13 that has not melted in the welding step. As shown in FIG. 3E, the second region 31b is formed when the depth a is shallower than the thickness b.

The second region 31b with few voids V is provided at a position adjacent to the welded portion 33. This structure can improve the strength in the vicinity of the welded portion 33 of the welded product 30. For example, when the inner space of the welded product 30 is sealed, the strength in the vicinity of the welded portion 33 is improved. Even if an impact is applied to the welded product 30, the seal in the space becomes difficult to break. The reliability of the welded product 30 can be improved.

As described above, the welding method according to the embodiment can suppress occurrence of defects at the welded portion between the first member and the second member. The method for manufacturing a welded product according to the embodiment can manufacture a welded product with less defects at the welded portion. The welded product according to the embodiment can improve the strength in the vicinity of the welded portion.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Moreover, above-mentioned embodiments can be combined mutually and can be carried out.

What is claimed is:

1. A welding method, comprising:
pretreatment of melting a part of the first member formed by die casting and solidifying the part of the first member; and
welding the first member and the second member by melting the solidified part of the first member and the second member in contact with each other.

2. The method according to claim 1, wherein in the welding, a depth of the first member to be melted is shallower than a thickness of the solidified part of the first member.

3. The method according to claim 1, wherein a heating temperature for melting the part of the first member in the welding is set lower than a heating temperature for melting the part of the first member in the pretreatment.

4. The method according to claim 1, further comprising cutting the first member,
in the welding, the cut first member and the second member being welded together.

5. The method according to claim 4, wherein
the cutting is performed after the pretreatment, and
in the cutting, the first member is cut so as to leave at least a portion of the solidified part of the first member.

6. The method according to claim 1, wherein the first member and the second member include aluminum.

7. The method according to claim 1, wherein
the first member includes a concave portion and a convex portion provided around the concave portion,
the part of the first member includes a surface of the convex portion,
in the welding, the first member and the second member are welded to seal a space surrounded by the concave portion, the convex portion, and the second member.

8. A method for manufacturing a welded product including a first member formed by die casting and a second member, comprising:
pretreatment of melting a part of the first member formed by die casting and solidifying the part of the first member; and
welding the first member and the second member by melting the solidified part of the first member and the second member in contact with each other.

9. A welded product, comprising:
a first portion including a metal; and
a second portion connected to the first portion via a welded portion,
the first portion including a first region apart from the welded portion and a second region provided between the first region and the welded portion,
a density of voids in the second region being lower than a density of voids in the first region.

10. The product according to claim 9, wherein
the first portion includes a concave portion and a convex portion provided around the concave portion,
the welded portion is provided along a circumferential direction between the convex portion and the second portion,
a space surrounded by the concave portion, the convex portion, and the second portion is sealed.
